(19) United States
(12) Patent Application Publication
(10) Pub. No.: US 2018/0225297 A1
(43) Pub. Date: Aug. 9, 2018

(54) Suggesting Apps and/or Items Based on Geographic Search Intent

(71) Applicant: Microsoft Technology Licensing, LLC, Redmond, WA (US)

(72) Inventors: Felix Gerard Torquil Ifor Andrew, Seattle, WA (US); Scott Andrew Borton, Seattle, WA (US); Tia Bianca Caldwell, Bellevue, WA (US); Chad Steven Estes, Woodinville, WA (US)

(73) Assignee: Microsoft Technology Licensing, LLC, Redmond, WA (US)

(21) Appl. No.: 15/427,273

(22) Filed: Feb. 8, 2017

(51) Int. Cl. G06F 17/30

(52) U.S. Cl. CPC G06F 17/3097; G06F 17/30241

(57) ABSTRACT

Described herein is a suggestion system that includes an input component configured to receive a search result. The memory further includes a suggestion algorithm component configured to determine a geographic item related to the search result and identify one or more suggested items based on the determined geographic item, received search result and metadata associated with stored items. The memory also includes an output component configured to provide information regarding the identified one or more suggested items.

### BACKGROUND

Applications (“apps”) can assist users by providing access to particular functionality and/or information. Apps are being developed at a very rapid pace with some application stores containing in excess of one million apps. With this ever increasing inventory of apps, a user can become frustrated attempting to discover relevant apps.

### SUMMARY

Described herein is a suggestion system, comprising a computer comprising a processor and a memory. The memory includes an input component configured to receive a search result from a mapping application of a user device. The memory further includes a suggestion algorithm component configured to determine a geographic item related to the search term and identify one or more suggested items based on the determined geographic item, received search result and metadata associated with stored item. The memory also includes an output component configured to provide information regarding the identified one or more suggested items.

Also described herein is a method of one or more contextually relevant applications. The method includes receiving a search result and determining a geographic item associated with the search result. The method further includes identifying one or more suggested apps based on the received search result, determined geographical item and metadata associated with stored apps; and providing information regarding the identified one or more suggested apps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates an application suggestion system.

FIG. 2 is a functional block diagram that illustrates an application suggestion system.

FIG. 3 is a functional block diagram that illustrates a suggestion system.

FIG. 4 illustrates an exemplary methodology of identifying one or more contextually relevant applications.

FIG. 5 illustrates an exemplary methodology of identifying contextually relevant applications.

FIG. 6 illustrates an exemplary methodology of identifying contextually relevant suggestions.

FIG. 7 is a functional block diagram that illustrates an exemplary computing system.

### DETAILED DESCRIPTION

Various technologies pertaining to identifying contextually relevant applications and/or items in response to a search are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding identifying contextually relevant applications and/or items in response to a user's search. What follows are one or more exemplary systems and methods.

Aspects of the subject disclosure pertain to the technical problem of identifying contextually relevant applications and/or items in response to a user's search. The technical features associated with addressing this problem involve determining a geographic item from the user's search and identifying apps and/or items based on the determined geographic item, user's search, contextual information and/or metadata associated with stored apps and/or items. Accordingly, aspects of these technical features exhibit technical effects of more efficiently and effectively identifying contextually relevant applications and/or items thus reducing user frustration.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

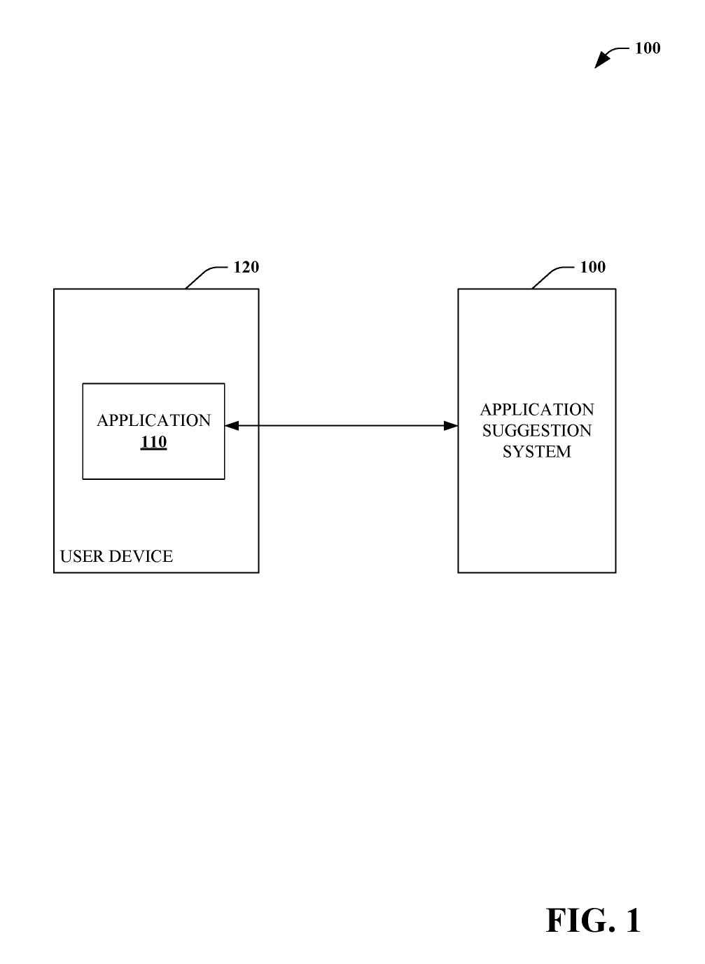

Referring to FIG. 1, an application suggestion system 100 is illustrated. The system 100 can identify contextually relevant apps to an application 110 (e.g., mapping application) of a user device 120. In one embodiment, the system 100 exposes application programming interface(s) (APIs) to the application 110 and returns information regarding one or more contextually relevant apps to the application 110.

In one embodiment, a user of the user device 120 can opt-in to providing search result(s) and/or contextual information to the application suggestion system 100. In one embodiment, the application 110 (e.g., mapping application) can provide a bounding rectangle along with search result(s) to the system 100.

In one embodiment, the application 110 comprises a mapping application which facilities searching for places (e.g., current and/or potential future location of user). By receiving search result(s) and/or contextual information from the application 110 (e.g., mapping application), the system 100 can complement and/or augment information provided to a user by the application (e.g., mapping application). For example, as discussed below, the system 100 can determine a geographic item associated with the search result(s) and/or contextual information. Using the determined geographic item, search result(s), contextual information and/or metadata associated with stored apps, the system can identify and suggest relevant apps to the application 110 (e.g., mapping application).

In one embodiment, an intent of the search is based on an upcoming event being held at a particular location, for example, a user desiring to attend a sporting event in Atlanta may start searching for hotels in Atlanta many months before the event starts. What the user may not know is that the user could install apps related to the sporting event, apps related to particular hotels, apps related to particular airlines, apps related to trip websites, etc. The system 100 can identify and suggest relevant apps to the application 110 (e.g., mapping application) based on the search result(s), contextual information, determined geographic item and/or metadata associated with stored apps.

In one embodiment, however, based on a search for the same particular location for a different time period (e.g., a time after the sporting event), the system 100 can identify different suggested apps because metadata associated with stored apps related to the sporting event indicates that apps related to the sporting event do not apply to the different time period.

While the system 100 has been discussed with respect to a mapping application, the application 110 can be any suitable application, for example, a music application to which the system 100 can return a list of upcoming bands and/or artists playing in an area being searched and time period relevant to the search.

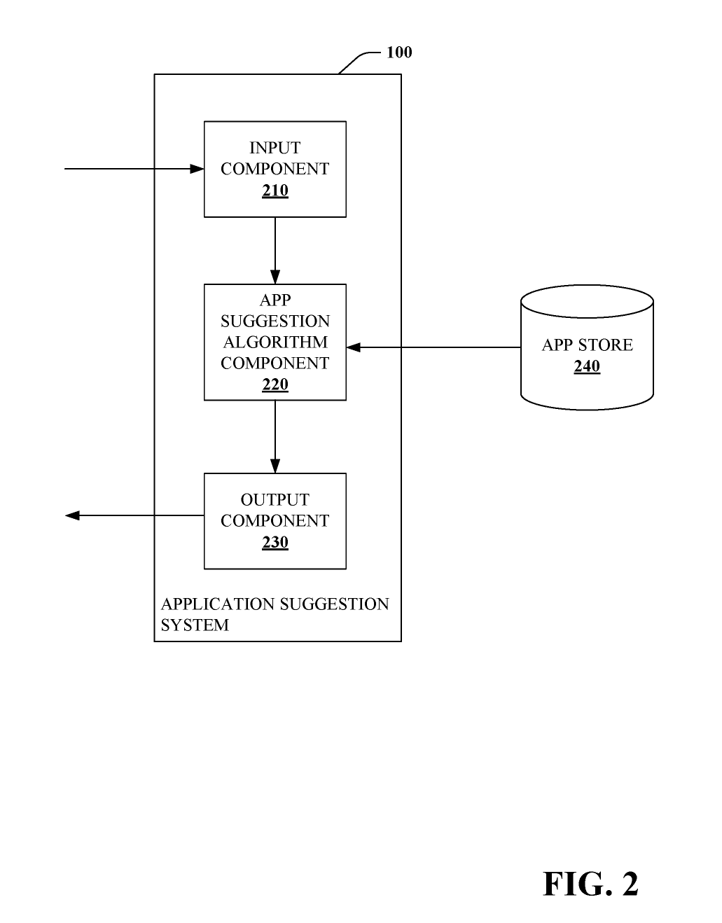

Turning to FIG. 2, the system 100 can include an input component 210, an app suggestion algorithm component 220 and an output component 230. The app suggestion algorithm component 220 can identify one or more apps stored in an app store 240 to suggest to the user.

In one embodiment, one or more apps stored in the app store 240 have metadata associated with the particular app. In one embodiment, the metadata can provide temporal information associated with the particular app (e.g., relevant to the particular app). In one embodiment, the metadata can provide geo-location information (e.g., a latitude and longitude radius) associated with the particular app. In one embodiment, the metadata can provide an event duration associated with the particular app.

In one embodiment, the metadata can identify date(s) associated with the particular app (e.g., for which the particular app is relevant). For example, for a particular event such as a football game, an app associated with the particular event can identify a time period during which the app is particularly relevant (e.g., one month period preceding the event). In one embodiment, the metadata can identify an expiration date for a particular app.

The input component 210 can receive search result(s) based, for example, upon a user's search entered into the application 110 (e.g., mapping application). In one embodiment, the input component 210 can receive contextual information associated with the user, the user device 120 and/or the search (e.g., physical location, date, time, etc.)

The app suggestion algorithm component 210 can determine a geographical item (e.g., city, state, country, ZIP code, event, longitude and latitude coordinates etc.) from the search result(s) and/or contextual information. In one embodiment, the determination can be implicit. For example, from a search for “Eiffel Tower” submitted to the application 110 (e.g., mapping application) while a user is physically located within the United States, the app suggestion algorithm component 210 can infer that the user intends to travel to Paris, France and see the Eiffel tower.

In one embodiment, the determination can be explicit. For example, from a search for “Eiffel Tower” submitted to the application 110 (e.g., mapping application) while a user is physically located in Paris, France, the app suggestion algorithm component 210 can determine the geographic item as “Eiffel Tower.”

Based upon the received search result(s), determined geographical item(s), contextual information, if any, metadata associated with stored apps, the app suggestion algorithm component 210 can identify one or more apps to suggest to the user. In one embodiment, identification can be based on category(ies) (e.g., travel) associated with the received search result(s).

The output component 230 can provide the identified one or more suggested apps to the application 110 of the user device 120. In one embodiment, the apps can be organized hierarchically with apps with high rankings being displayed to the user more prominently. In one embodiment, the application 110 can identify a point of interest on a map (e.g., based on the determined geographic item) and provide information regarding the identified one or suggested apps.

In one embodiment, upon selection of one of the identified suggested apps, an application store can be launched to install the selected app and/or allow a user to read reviews of the selected app. In one embodiment, upon selection of one of the identified suggested apps, if the app is determined to already be installed, the selected app can with launched with a latitude and a longitude associated with the search.

In one embodiment, upon selection of one of the identified suggested apps, the selected app can be provided with at least a portion of the search result(s), contextual information received and/or determined geographic item(s). Referring back to the example search for “Eiffel Tower” submitted to the application 110 (e.g., mapping application) while a user is physically located within the United States, the app suggestion algorithm component 210 can infer that the user intends to travel to Paris, France and see the Eiffel tower. Accordingly, the suggestion algorithm component 210 can suggest apps related to travel (e.g., airlines, car rentals etc.), lodging (e.g., hotels, bed and breakfasts, etc.) and sightseeing tours. In response to selecting an app associated with a particular airline, the selected app can receive information regarding the determined geographic item (e.g., Paris, France) along with the physical location from which the user is searching (e.g., location within the United States). For example, when launching the selected app, the selected app can utilize the received information to present potentially meaningful information to the user (e.g., pre-populated search form for flights from the location within the United States to Paris, France).

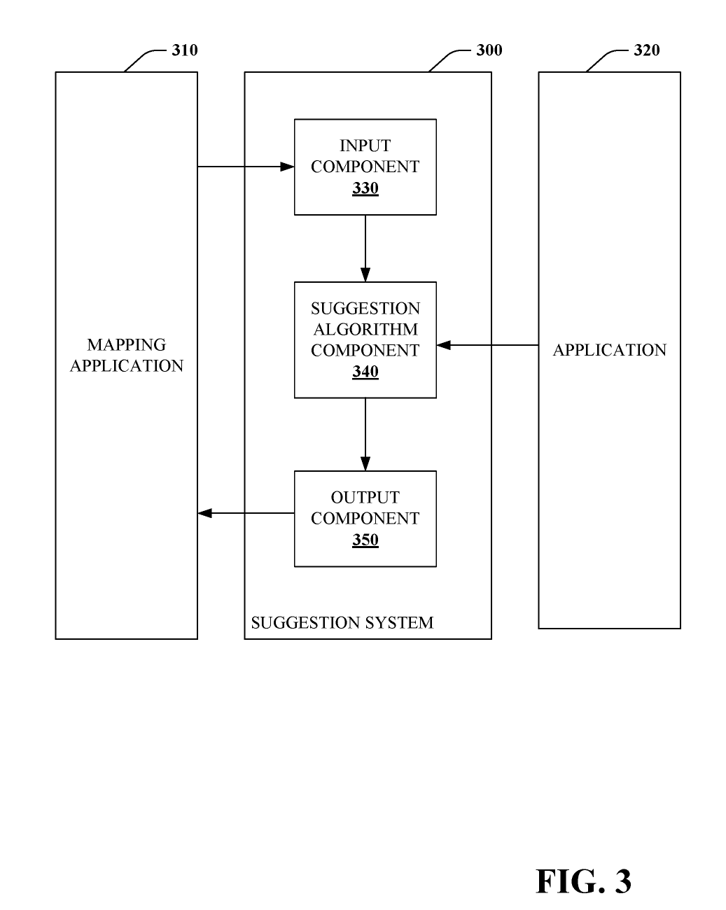

Referring to FIG. 3, a suggestion system 300 is illustrated. The system 300 can identify contextually relevant suggested items, for example, to a mapping application 310 of a user device. In one embodiment, the system 300 exposes application programming interface(s) (APIs), for example, to the mapping application 310 and returns information regarding one or more contextually relevant suggested items (e.g., to the mapping application 310).

In one embodiment, a user can opt-in to providing search result(s) and/or contextual information to the suggestion system 300. In one embodiment, the mapping application 310 can provide a bounding rectangle along with search result(s) to the system 300.

In one embodiment, the mapping application 310 facilities searching for places (e.g., current and/or potential future location of user). By receiving search result(s) and/or contextual information from the mapping application 310, the system 300 can complement and/or augment information provided to a user by the mapping application 310. For example, the system 300 can determine a geographic item associated with the search result(s) and/or contextual information. Using the determined geographic item, search result(s), contextual information and/or information received from an application 340 (e.g., music and/or food application), the system 300 can provide suggested items to the mapping application 310.

In one embodiment, an intent of the search is based on an upcoming event being held at a particular location. The system 300 can identify and suggest relevant items to the mapping application 310 based on the search result(s), contextual information, determined geographic item and/or information received from an application 340 (e.g., music and/or food application). For example, the application 320 can be a music application to which the system 300 can return a list of upcoming bands and/or artists playing in an area being searched and time period relevant to the search.

The system 300 can include an input component 330, a suggestion algorithm component 340 and/or an output component 350. The suggestion algorithm component 340 can identify one or more suggested items.

In one embodiment, one or more items associated with the application 320 have metadata associated with the item. In one embodiment, the metadata can provide temporal information associated with the particular item (e.g., relevant to the particular item). In one embodiment, the metadata can provide geo-location information (e.g., a latitude and longitude radius) associated with the particular item. In one embodiment, the metadata can provide an event duration associated with the particular item.

In one embodiment, the metadata can identify date(s) associated with the particular item (e.g., for which the particular item is relevant). For example, for a particular item such as a music concert, the metadata associated with the item can identify a time period during which the item is particularly relevant (e.g., one month period preceding the event). In one embodiment, the metadata can identify an expiration date for a particular item.

The input component 330 can receive search result(s) based, for example, upon a user's search entered into the mapping application 310. In one embodiment, the input component 330 can receive contextual information associated with the user, the user device and/or the search (e.g., physical location, date, time, etc.)

The suggestion algorithm component 340 can determine a geographical item (e.g., city, state, country, ZIP code, event, longitude and latitude coordinates etc.) from the search result(s) and/or contextual information. In one embodiment, the determination can be implicit. In one embodiment, the determination can be explicit.

Based upon the received search result(s), determined geographical item(s), contextual information, if any, metadata associated with items, the suggestion algorithm component 340 can identify one or more suggested items. In one embodiment, identification can be based on category(ies) (e.g., travel) associated with the received search result(s).

The output component 350 can provide the identified one or more suggested items to the mapping application 310. In one embodiment, the suggestions can be organized hierarchically with suggestions with high rankings being displayed to the user more prominently. In one embodiment, the mapping application 310 can identify a point of interest on a map (e.g., based on the determined geographic item) and provide information regarding the identified one or suggested items.

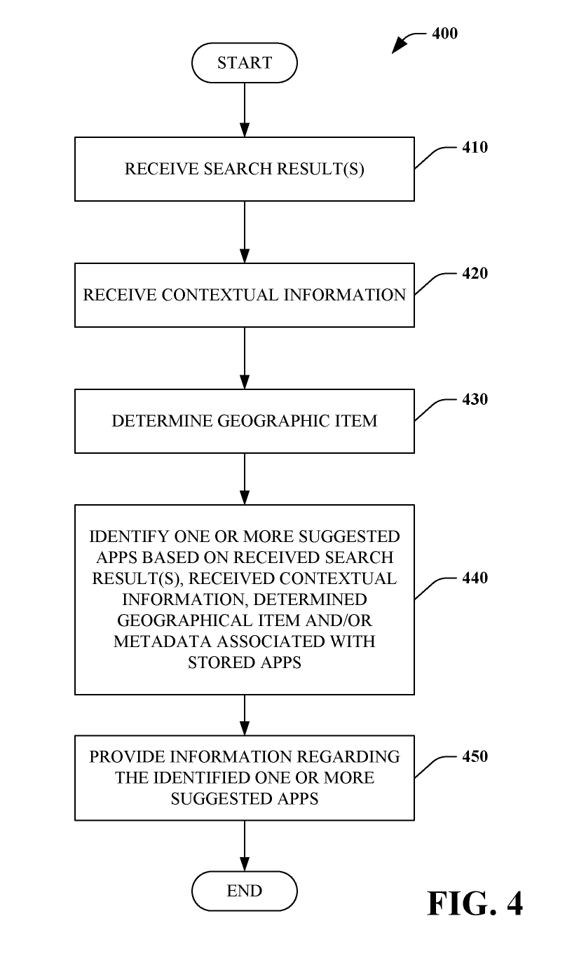

FIGS. 4-6 illustrate exemplary methodologies relating to identifying contextually relevant applications and/or suggested items in response to a search. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 4, a method of identifying one or more contextually relevant applications 400 is illustrated. At 410, search result(s) are received. For example, the search result(s) can be received by the application 110 (e.g., mapping application) of the user device 120.

At 420, contextual information is received, for example, physical location of user device, date, time, etc. At 430, a geographic item is determined from the search result(s) and contextual information.

At 440, one or more suggested apps are identified based on the received search result(s), received contextual information, determined geographical item and/or metadata associated with stored apps. At 450, information regarding the identified one or more suggested apps is provided, for example, to an application 110 of a user device 120.

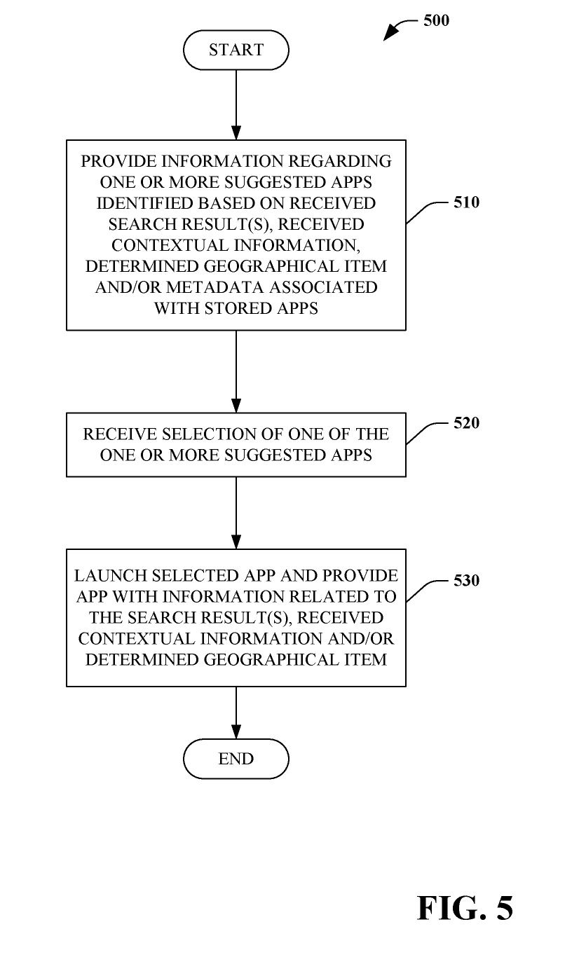

Turning to FIG. 5, a method of identifying contextually relevant applications 500 is illustrated. At 510, information is provided to a user regarding one or more suggested apps identified based on received search result(s), received contextual information, determined geographical item and/or metadata associated with stored apps. At 520, a selection of one of the one or more suggested apps is received from the user. At 530, the selected suggested apps is launched and provided with information related to the search result(s), received contextual information and/or determined geographical item.

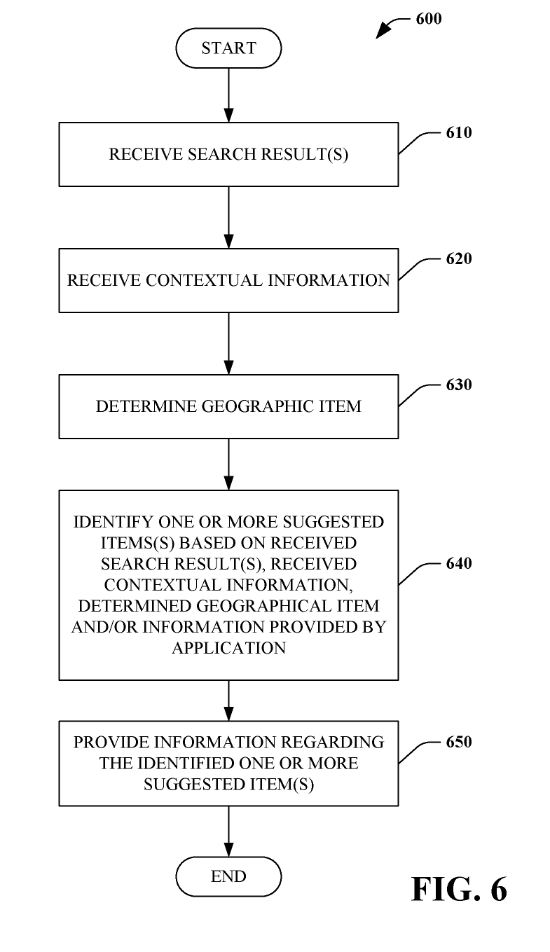

Referring to FIG. 6, a method of identifying contextually relevant suggested items 600 is illustrated. At 610, search result(s) are received. For example, the search result(s) can be received from the mapping application 310 of a user device.

At 620, contextual information is received, for example, physical location of user device, date, time, etc. At 630, a geographic item is determined from the search result(s) and contextual information.

At 640, one or more suggested items are identified based on the received search result(s), received contextual information, determined geographical item and/or information received from an application (e.g., music and/or food application). At 650, information regarding the identified one or more suggested items is provided, for example, to the mapping application 310 of the user device.

Described herein is a suggestion system comprising a computer comprising a processor and a memory. The memory comprises an input component configured to receive a search result from a mapping application of a user device, a suggestion algorithm component configured to determine a geographic item related to the search result and identify one or more suggested items based on the determined geographic item, received search result and metadata associated with stored items; and an output component configured to provide information regarding the identified one or more suggested items.

The system can include wherein the input component is further configured to receive contextual information regarding the user device. The system can include wherein the suggestion algorithm component is further configured to determine the geographic item based on the contextual information and to identify the one or more suggested items based on the contextual information. The system can further include wherein the contextual information comprises a physical location of the user device, a date associated with a search or a time associated with the search.

The system can include application programming interfaces for communication with the mapping application. The system can further include wherein a user of the user device opts-in to providing the search result and/or contextual information to the system. The system can include wherein the metadata comprises temporal information associated with a particular item.

The system can include wherein the metadata identifies at one of one or more dates associated with a particular item or an expiration date for the particular item. The system can further include wherein the metadata identifies geo-location information associated with a particular item. The system can include wherein the determination of the geographic item is inferred from the search result and/or received contextual information.

Described herein is a method of one or more contextually relevant applications, comprising receiving a search result, determining a geographic item associated with the search result, identifying one or more suggested apps based on the received search result, determined geographical item and metadata associated with stored apps; and providing information regarding the identified one or more suggested apps. The method can include wherein identifying one or more suggested apps is further based on received contextual information.

The method can further include wherein determining the geographic item is further based on contextual information. The method can include wherein the search result is received via an application programming interface. The method can include wherein the metadata comprises temporal information associated with a particular app.

The method can further include wherein the metadata identifies at least one of one or more dates associated with a particular app, an expiration date for the particular app or geo-location information associated with the particular app.

Described herein is a computer storage media storing computer-readable instructions that when executed cause a computing device to receive a search term and contextual information, determine a geographic item associated with the search term and the contextual information, identify one or more suggested apps based on the received search term, received contextual information, determined geographical item and metadata associated with stored apps; and provide information regarding the identified one or more suggested apps.

The computer storage media can further include wherein the metadata identifies at least one of one or more dates associated with a particular app or an expiration date for the particular app. The computer storage media can include wherein the metadata identifies geo-location information associated with a particular app. The computer storage media can store further computer-readable instructions that when executed cause the computing device to, in response to a user selection of one of the suggested apps, launch the selected suggested app and provide at least a portion of the search term, received context information or determined geographic item to the selected suggest app.

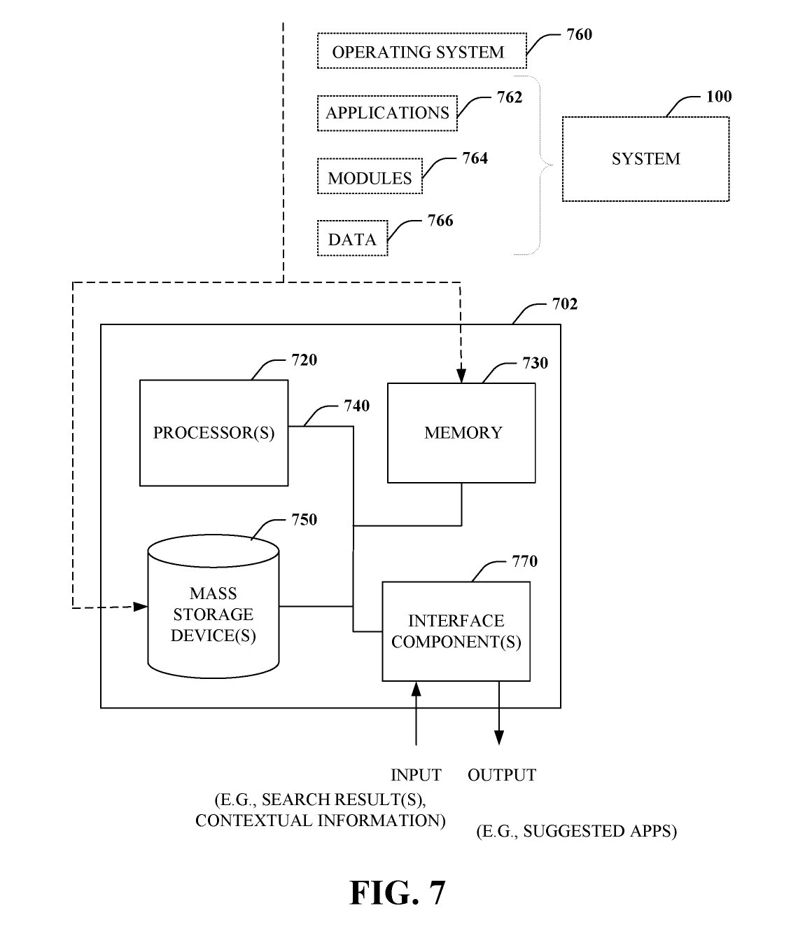

With reference to FIG. 7, illustrated is an example general-purpose computer or computing device 702 (e.g., mobile phone, desktop, laptop, tablet, watch, server, hand-held, programmable consumer or industrial electronics, set-top box, game system, compute node, etc.). For instance, the computing device 702 may be used in an application suggestion system 100 and/or a suggestion system 300.

The computer 702 includes one or more processor(s) 720, memory 730, system bus 740, mass storage device(s) 750, and one or more interface components 770. The system bus 740 communicatively couples at least the above system constituents. However, it is to be appreciated that in its simplest form the computer 702 can include one or more processors 720 coupled to memory 730 that execute various computer executable actions, instructions, and or components stored in memory 730. The instructions may be, for instance, instructions for implementing functionality described as being carried out by one or more components discussed above or instructions for implementing one or more of the methods described above.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 720 can be a graphics processor.

The computer 702 can include or otherwise interact with a variety of computer-readable media to facilitate control of the computer 702 to implement one or more aspects of the claimed subject matter. The computer-readable media can be any available media that can be accessed by the computer 702 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 702. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 730 and mass storage device(s) 750 are examples of computer-readable storage media. Depending on the exact configuration and type of computing device, memory 730 may be volatile (e.g., RAM), non-volatile (e.g., ROM, flash memory, etc.) or some combination of the two. By way of example, the basic input/output system (BIOS), including basic routines to transfer information between elements within the computer 702, such as during start-up, can be stored in nonvolatile memory, while volatile memory can act as external cache memory to facilitate processing by the processor(s) 720, among other things.

Mass storage device(s) 750 includes removable/non-removable, volatile/non-volatile computer storage media for storage of large amounts of data relative to the memory 730. For example, mass storage device(s) 750 includes, but is not limited to, one or more devices such as a magnetic or optical disk drive, floppy disk drive, flash memory, solid-state drive, or memory stick.

Memory 730 and mass storage device(s) 750 can include, or have stored therein, operating system 760, one or more applications 762, one or more program modules 764, and data 766. The operating system 760 acts to control and allocate resources of the computer 702. Applications 762 include one or both of system and application software and can exploit management of resources by the operating system 760 through program modules 764 and data 766 stored in memory 730 and/or mass storage device (s) 750 to perform one or more actions. Accordingly, applications 762 can turn a general-purpose computer 702 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 762, and include one or more modules 764 and data 766 stored in memory and/or mass storage device(s) 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 702 also includes one or more interface components 770 that are communicatively coupled to the system bus 740 and facilitate interaction with the computer 702. By way of example, the interface component 770 can be a port (e.g., serial, parallel, PCMCIA, USB, FireWire, etc.) or an interface card (e.g., sound, video, etc.) or the like. In one example implementation, the interface component 770 can be embodied as a user input/output interface to enable a user to enter commands and information into the computer 702, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 770 can be embodied as an output peripheral interface to supply output to displays (e.g., LCD, LED, plasma, etc.), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A suggestion system, comprising:
a computer comprising a processor and a memory, the memory comprising:
an input component configured to receive a search result from a mapping application of a user device;
a suggestion algorithm component configured to determine a geographic item related to the search result and identify one or more suggested items based on the determined geographic item, received search result and metadata associated with stored items; and
an output component configured to provide information regarding the identified one or more suggested items.

2. The system of claim 1, wherein the input component is further configured to receive contextual information regarding the user device.

3. The system of claim 2, wherein the suggestion algorithm component is further configured to determine the geographic item based on the contextual information and to identify the one or more suggested items based on the contextual information.

4. The system of claim 2, wherein the contextual information comprises a physical location of the user device, a date associated with a search or a time associated with the search.

5. The system of claim 1, further comprising application programming interfaces for communication with the mapping application.

6. The system of claim 1, wherein a user of the user device opts-in to providing the search result and/or contextual information to the system.

7. The system of claim 1, wherein the metadata comprises temporal information associated with a particular item.

8. The system of claim 1, wherein the metadata identifies at one of one or more dates associated with a particular item or an expiration date for the particular item.

9. The system of claim 1, wherein the metadata identifies geo-location information associated with a particular item.

10. The system of claim 1, wherein the determination of the geographic item is inferred from the search result and/or received contextual information.

11. A method of one or more contextually relevant applications, comprising:
receiving a search result;
determining a geographic item associated with the search result;
identifying one or more suggested apps based on the received search result, determined geographical item and metadata associated with stored apps; and
providing information regarding the identified one or more suggested apps.

12. The method of claim 11, wherein identifying one or more suggested apps is further based on received contextual information.

13. The system of claim 11, wherein determining the geographic item is further based on contextual information.

14. The system of claim 11, wherein the search result is received via an application programming interface.

15. The system of claim 11, wherein the metadata comprises temporal information associated with a particular app.

16. The system of claim 11, wherein the metadata identifies at least one of one or more dates associated with a particular app, an expiration date for the particular app or geo-location information associated with the particular app.

17. A computer storage media storing computer-readable instructions that when executed cause a computing device to:
receive a search term and contextual information;
determine a geographic item associated with the search term and the contextual information;
identify one or more suggested apps based on the received search term, received contextual information, determined geographical item and metadata associated with stored apps; and
provide information regarding the identified one or more suggested apps.

18. The computer storage media of claim 17, wherein the metadata identifies at least one of one or more dates associated with a particular app or an expiration date for the particular app.

19. The computer storage media of claim 17, wherein the metadata identifies geo-location information associated with a particular app.

20. The computer storage media of claim 18, storing further computer-readable instructions that when executed cause the computing device to, in response to a user selection of one of the suggested apps, launch the selected suggested app and provide at least a portion of the search term, received context information or determined geographic item to the selected suggest app.
